(19) United States
(12) Patent Application Publication
(10) Pub. No.: US 2025/0372754 A1
(43) Pub. Date: Dec. 4, 2025

(54) CONTROL OF ALTERNATING CURRENT BATTERY HEATING TO GENERATE SOUNDS

(71) Applicant: GM Global Technology Operations LLC, Detroit, MI (US)

(72) Inventors: Renato Amorim Torres, Pontiac, MI (US); Suresh Gopalakrishnan, Troy, MI (US); Neeraj S. Shidore, Novi, MI (US); Song He, Troy, MI (US); Madhusudan Raghavan, West Bloomfield, MI (US); Mark R. Claywell, Birmingham, MI (US)

(21) Appl. No.: 18/677,265

(22) Filed: May 29, 2024

(51) Int. Cl. H01M 10/633; B60Q 9/00; G10K 15/04; H01M 10/48; H01M 10/615; H01M 10/625; H01M 10/657

(52) U.S. Cl. CPC H01M 10/633; B60Q 9/00; G10K 15/04; H01M 10/48; H01M 10/615; H01M 10/625; H01M 10/657

(57) ABSTRACT

A system for thermal control of a battery system includes a heating control module configured to generate an alternating current (AC) heating current and heat the battery system to a desired temperature by applying the AC heating current to the battery system. The heating control module is configured to control a shape of the AC heating current to cause a component of the battery system to emit a selected sound pattern having a selected frequency, amplitude and shape.

### INTRODUCTION

The subject disclosure relates to thermal control of batteries, and more specifically, to heating a battery assembly or system using an applied electrical current and controlling sound generated by the heating.

Vehicles, including gasoline and diesel power vehicles, as well as electric and hybrid electric vehicles, feature battery storage for purposes such as powering electric motors, electronics and other vehicle subsystems. Many battery systems and electric vehicles feature thermal control systems for heating battery modules to maintain proper operating temperatures. Some thermal control systems include capabilities for heating battery modules using an applied alternating current to achieve a desired temperature at a desired heating rate.

### SUMMARY

In one exemplary embodiment, a system for thermal control of a battery system includes a heating control module configured to generate an alternating current (AC) heating current and heat the battery system to a desired temperature by applying the AC heating current to the battery system. The heating control module is configured to control a shape of the AC heating current to cause a component of the battery system to emit a selected sound pattern having a selected frequency, amplitude and shape.

In addition to one or more of the features described herein, the component of the battery system includes at least one of an inverter, an electric motor connected to the inverter, and a motor housing.

In addition to one or more of the features described herein, the heating control module is configured to control a heating current frequency to cause the component to generate the selected sound pattern.

In addition to one or more of the features described herein, the heating control module is configured to change the heating current frequency to generate a plurality of successive tones.

In addition to one or more of the features described herein, the change of the heating current frequency is made during a zero-crossing of the AC heating current, and a phase of the AC heating current is controlled to provide a smooth transition between the successive tones.

In addition to one or more of the features described herein, each tone of the plurality of successive tones has a respective frequency selected to generate a musical pattern.

In addition to one or more of the features described herein, the heating control module is configured to control the shape of the heating current to generate a simultaneous combination of consonant musical tones.

In addition to one or more of the features described herein, the heating control module is configured to control the shape of the heating current to generate a pattern of one or more tones, the pattern indicative of at least one of: a condition of the battery system and a status of a battery heating process.

In another exemplary embodiment, a method of thermally controlling a battery system of a vehicle includes controlling a heating control module to generate an alternating current (AC) heating current, heating the battery system to a desired temperature by applying the AC heating current to the battery system during a battery heating process, and during the battery heating process, controlling a shape of the AC heating current to cause a component of the battery system to emit a selected sound pattern having a selected frequency, amplitude and shape.

In addition to one or more of the features described herein, the component of the battery system includes at least one of an inverter, an electric motor connected to the inverter, and a motor housing.

In addition to one or more of the features described herein, controlling the shape including controlling a heating current frequency to cause the component to generate the selected sound pattern.

In addition to one or more of the features described herein, the shape of the AC heating current is controlled so that the AC heating current defines a plurality of successive tones, and controlling the shape includes changing the heating current frequency at a selected time to transition between adjacent tones, wherein the heating current frequency is changed at zero-crossing of the AC heating current, and a phase of the AC heating current is controlled to provide a smooth transition between the adjacent tones.

In addition to one or more of the features described herein, controlling the shape of the AC heating current includes selecting an amplitude of the AC heating current based on a transfer function, the transfer function relating the amplitude to a volume of the selected sound pattern based on characteristics of the vehicle.

In addition to one or more of the features described herein, the shape of the AC heating current is controlled to generate a simultaneous combination of consonant musical tones.

In addition to one or more of the features described herein, the shape of the AC heating current is controlled to generate a pattern of one or more tones, the pattern indicative of at least one of: a condition of the battery system and a status of a battery heating process.

In yet another exemplary embodiment, a vehicle system includes a memory having computer readable instructions, and a processing device for executing the computer readable instructions, the computer readable instructions controlling the processing device to perform a method that includes controlling a heating control module to generate an alternating current (AC) heating current, and heating a battery system to a desired temperature by applying the AC heating current to the battery system during a battery heating process. The method includes, during the battery heating process, controlling a shape of the AC heating current to cause a component of the battery system to emit a selected sound pattern having a selected frequency, amplitude and shape, where the component of the battery system includes at least one of an inverter, an electric motor connected to the inverter, and a motor housing.

In addition to one or more of the features described herein, the shape of the AC heating current is controlled to generate a simultaneous combination of consonant musical tones.

In addition to one or more of the features described herein, controlling the shape including controlling a heating current frequency to cause the component to generate the selected sound pattern.

In addition to one or more of the features described herein, the selected sound pattern includes a plurality of successive tones, each successive tone having a respective frequency selected to generate a musical pattern.

In addition to one or more of the features described herein, the shape of the AC heating current is controlled to generate a pattern of one or more tones, the pattern indicative of at least one of: a condition of the battery system and a status of a battery heating process.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a top view of a motor vehicle including a battery assembly or system and a battery heating system, in accordance with an exemplary embodiment;

FIG. 2 depicts a portion of a motor propulsion system, including components used by a battery heating system, in accordance with an exemplary embodiment;

FIG. 3 schematically depicts a vehicle system including various control devices and components for battery heating control;

FIG. 4 is a flow diagram depicting aspects of a method of heating a battery system and controlling one or more parameters of applied heating current to generate selected tones or other sound patterns, in accordance with an exemplary embodiment;

FIG. 5 depicts an example of a heating current waveform configured to cause vehicle components to generate a sound pattern that includes successive tones or musical notes, in accordance with an exemplary embodiment;

FIG. 6 depicts an example of a heating current waveform configured to cause vehicle components to generate a harmonic sound pattern, in accordance with an exemplary embodiment; and

FIG. 7 depicts a computer system in accordance with an exemplary embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features.

In accordance with an exemplary embodiment, methods, devices and systems are provided for thermal control of battery systems, such as vehicle battery systems. An embodiment of a battery heating system is configured to heat or increase the temperature of a battery system (e.g., a battery pack) by applying an alternating current (AC) to the battery system. The battery heating system is configured to control heating parameters (e.g., frequency, current amplitude) of an AC heating current in order to generate a desired sound profile or pattern that is audible to a driver or other vehicle user during a battery heating process.

The sound profile or pattern may be selected to be pleasing to the user, to improve the user experience. For example, the parameters of the AC heating current are controlled to generate a selected tone, or generate a song, melody or any pattern of tones. In addition, or alternatively, the parameters are controlled to generate a sound pattern or profile that imparts information to a user. For example, the frequency of the AC heating current and/or the amplitude of the AC heating current is adjusted as a function of temperature, so that the sound frequency (tone) and/or sound volume is indicative of temperature values, temperature changes, heating status, vehicle conditions and/or other conditions or events. The sound frequency and/or sound volume may also be controlled or varied to make emitted sounds more pleasing to a user and enrich the user experience.

Embodiments described herein present numerous advantages and technical effects. The embodiments provide for additional functionality during battery heating, which is effective for improving the user experience. In addition, embodiments are capable of using existing components and processes to impart information to a user, which can provide additional monitoring capabilities.

During AC heating operations, audible noise may be generated by vehicle components, such as an electric motor and an inverter. Such noise can be loud and unpleasing (e.g., noise generated as pure tonal sound can be annoying to human ears), and may also be confusing (e.g., a user may be concerned as to whether the unpleasant noise represents a defect or a faulty condition). Embodiments improve a user experience by making this noise more pleasing to the user and converting the noise into something meaningful and useful. For example, by providing a more pleasing sound (e.g., a pleasant tone or melody), a user's concern is alleviated. In addition, the noise can be converted to provide information to a user. In some embodiments, a user can select a melody which can be converted by the control system into audio signals during AC heating, allowing a customized user experience.

The embodiments are not limited to use with any specific vehicle and may be applicable to various contexts. For example, embodiments may be used with automobiles, trucks, aircraft, construction equipment, farm equipment, automated factory equipment and/or any other device or system for which additional thermal control may be desired to facilitate a device or system's existing thermal control capabilities or features.

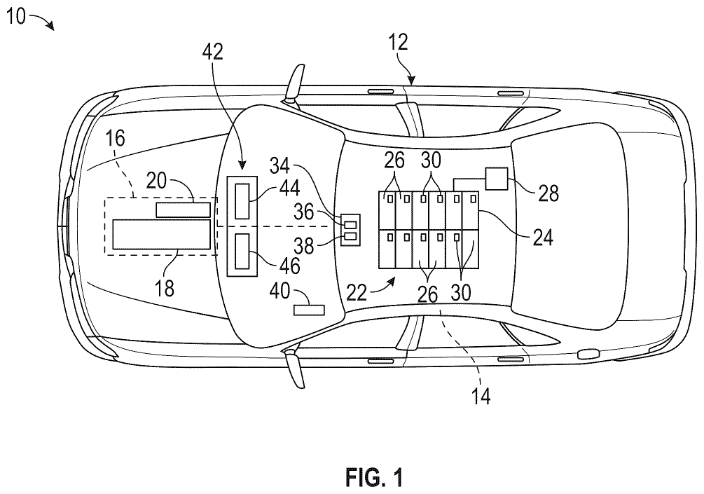

FIG. 1 shows an embodiment of a motor vehicle 10, which includes a vehicle body 12 defining, at least in part, an occupant compartment 14. The vehicle body 12 also supports various vehicle subsystems including a propulsion system 16, and other subsystems to support functions of the propulsion system 16 and other vehicle components, such as a braking subsystem, a suspension system, a steering subsystem, a fuel injection subsystem, an exhaust subsystem and others.

The vehicle may be an electrically powered vehicle (EV) or a hybrid electric vehicle (HEV). In an example, the vehicle 10 is a hybrid vehicle that includes a combustion engine 18 and an electric motor 20. Embodiments are not so limited and can be incorporated into other types of vehicles where batteries are present (e.g., fuel cell vehicles and hybrid fuel cell vehicles).

The vehicle 10 includes a battery system 22, which may be electrically connected to the motor 20 and/or other components, such as vehicle electronics. In an embodiment, the battery system 22 includes a battery assembly such as a high voltage battery pack 24 having a plurality of battery modules 26. Each of the battery modules 26 includes a number of individual cells (not shown). The battery system 22 may also include a monitoring unit 28 configured to receive measurements from sensors 30. Each sensor 30 may be an assembly or system having one or more sensors for measuring various battery and environmental parameters, such as temperature, current and voltages. The monitoring unit 28 includes components such as a processor, memory, an interface, a bus and/or other suitable components.

The battery system 22 includes one or more conversion devices for controlling the supply of power from the battery pack 24 to the motor 20 and/or electronic components.

The one or more conversion devices include an inverter circuit 34 (referred to herein as an inverter 34). The inverter 34 receives direct current (DC) power from the battery pack 24 and converts DC power to AC power that is supplied to the electric motor 20. In some cases, a DC-DC converter (not shown) may be included between the battery pack 24 and the inverter 34 for conversion of DC power signals from the battery pack 24. The inverter 34 includes one or more sets of switches or switching devices (e.g., controllable semiconductor switches such as metal-oxide-semiconductor field-effect transistors (MOSFETs)) that are controllable to supply AC power to each phase of the motor 20.

Components of the vehicle 10 form all or part of a heating system configured to generate an AC signal (also referred to as an “AC current,” a “heating current” or an “AC heating current”) and apply the AC heating current to the battery pack 24. The heating system may be used to heat the battery pack 24 during vehicle motion, when the vehicle 10 is operating and at a stand-still, and/or during charging of the vehicle 10.

In an embodiment, the heating system is configured to use energy generated by the battery pack 24 and an electric motor and/or charging station (or other energy source) to apply an AC heating current to the battery pack 24 by controlling a conversion device (e.g., the inverter 34).

The vehicle 10 includes various control devices for controlling aspects of vehicle systems. For example, an inverter controller 36 is provided to control aspects of signal conversion (e.g., gate drive control). A motor control unit (MCU) 38 controls aspects of motor operation, including generating modulated phase currents applied to the motor 20. The MCU 38 may be used to control battery heating processes.

One or more of the control devices is configured to control AC heating parameters to modify sounds produced by vehicle components during battery heating. For example, frequency and/or amplitude of AC heating currents are controlled (within limits, such that the heating process is not substantially impacted) to produce desired sound patterns, such as various tones or tone patterns. This sound control is described further herein.

Battery heating and/or sound control may be achieved using an existing controller or combination of controllers. For example, battery heating and sound generation is controlled by the MCU 38 (e.g., in coordination with the inverter controller 36 and/or monitoring unit 28). In another example, a dedicated controller such as a control module 40 is included and communicates with other controllers for control of AC heating current to cause emission of desired sound patterns.

It is noted that the heating system is not limited to the system shown in FIG. 1. The heating system may include any suitable device or component (installed in the vehicle or external to the vehicle) that can apply an AC heating current to a battery system.

The vehicle 10 may include a computer system 42 having one or more processing devices 44 and a user interface 46. The user interface may be a touchscreen, heads up display or other suitable display device. The user interface may be used to provide information to the user and allow the user to input requests, preferences and other information. For example, the user can use the interface 46 to provide preferences such as tones or patterns associated with heating or battery parameters (e.g., temperature, heating rate, etc.), songs or melodies, and others. In addition, the user interface can display options for available sound patterns and their meanings. The various processing devices and units may communicate with one another via a communication device or system, such as a controller area network (CAN) or transmission control protocol (TCP) bus.

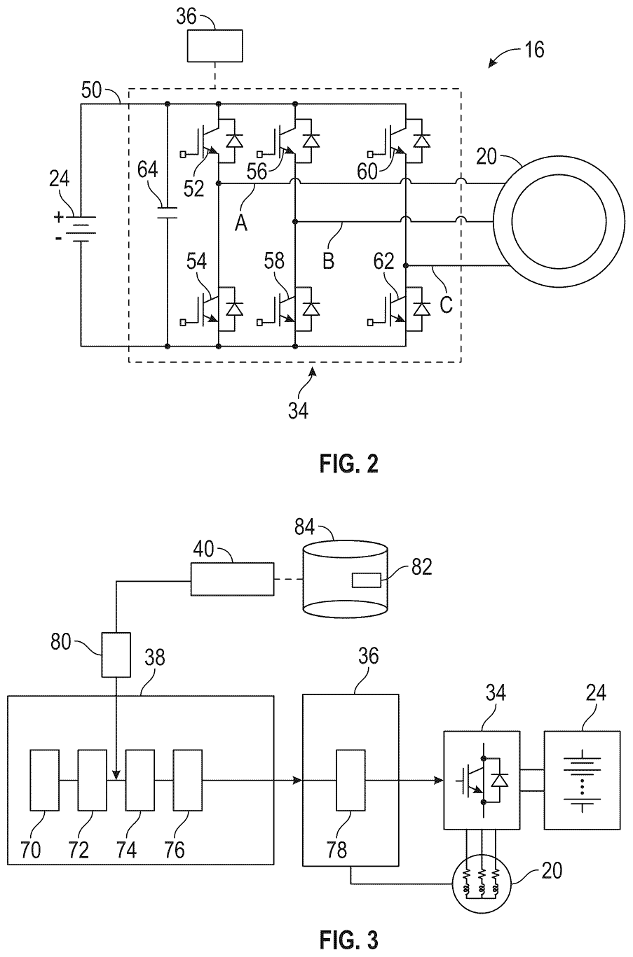

FIG. 2 depicts components of the propulsion system 16 and the battery pack 24, including components of an embodiment of the heating system. The propulsion system includes the inverter 34 coupled to the motor 20. Components of the inverter 34 are employed as part of the heating system and controlled by one or more control devices (e.g., the inverter controller 36 and/or the MCU 38 (FIG. 1)) to apply an AC heating current to heat the battery pack 24.

In an embodiment, the inverter 34 is a three-phase inverter connected to the battery pack 24 via a DC propulsion bus 50. The inverter 34 includes three sets of switches connected in parallel to one another and connected to the battery pack 24 and the motor 20. Each set of switches is in a half-bridge configuration. A first set of switches 52 and 54 is connected to a first motor phase (phase A), a second set of switches 56 and 58 connected to a second motor phase (phase B), and a third set of switches 60 and 62 is connected to a third motor phase (phase C). A capacitor 64 is connected in parallel to the sets of switches for filtering out current ripple.

During a battery heating process, the one or more control devices provide a control signal, such as a pulse width modulation (PWM) signal, having a selected amplitude, period between pulses and pulse widths. The PWM signal is applied to a set of switches (e.g., a pair of switches connected to a phase leg of the motor 20) to apply a heating current having a selected amplitude and frequency. The control signal is adjusted based on a desired amount of heating and rate of temperature increase by adjusting signal parameters such as pulse width, duty cycle, frequency, signal amplitude and others. The control signal is also adjusted to control parameters of the AC heating current, to cause one or more components (e.g., the inverter 34 and the motor 20) to generate sound having one or more selected frequencies, sounds and sound patterns as described further herein.

During a heating duration or cycle, the battery temperature is continuously or periodically monitored to determine when the battery system 22 is sufficiently heated, and to ensure that the battery system 22 is not excessively heated. The temperature may also be monitored to so that the AC heating current can be controlled to increase the temperature at a controlled rate.

FIG. 3 schematically illustrates components of the propulsion system 16 and the battery system 22 of the vehicle 10, as well as aspects of battery heating control and sound generation.

During vehicle operation (propulsion), the MCU 38 receives a torque command Te*, which is input to a torque-limiting module 70. The torque-limiting module 70 regulates the torque command to stay within various limits. The regulated torque command is provided to a current command generation module 72, which outputs direct (d-axis) current commands Id* and quadrature (q-axis) current commands Iq *. The commands Id* and Iq* are provided to a current regulator 74, which outputs d-q voltage commands Vs* and Vq *. In an embodiment, the current regulator 74 has a resonant controller structure.

A pulse width modulation (PWM) module 76 receives the d-q voltage commands Vs* and Vq* and generates PWM signals for each phase of the motor 20 to the inverter control module 36. The inverter control module 36 includes a gate drive control module 78 that operates gate drivers for each of the switches 52, 54, 56, 58, 60, 62 according to the PWM signals.

When used for battery heating, the MCU 38, or other suitable processing device (e.g., a battery monitoring system (BMS) controller), generates a command for an AC heating current to be applied to the battery pack 24. For example, a pulsating d-axis command 80 is input to the current regulator 74, which has a selected amplitude and frequency. The current regulator 74 provides a voltage command to the PWM module 76 to apply a PWM signal to one of the phases of the motor 20 via a phase leg of the inverter 34. The applied PWM signal results in an oscillating AC current through the motor 20 that is applied to the battery pack 24. In an embodiment, d-axis current is exclusively or primarily used as the AC heating current; however, q-axis current may also be used for AC current heating.

During AC heating, audible noise may be generated by the motor 20 (or motor housing) and/or the inverter 34. Motor noise may be due to tangential vibration in a motor housing, and is most dominant at higher noise levels. Inverter noise may be due to high frequency switching noise generated by operation of switches.

In an embodiment, the heating system is configured to control AC heating current in order to change the audible output. Components of the vehicle 10 that emit noise during AC heating can thus be operated as “speakers” to output desired sounds, tones and sound patterns.

To generate desired sounds, such as one or more tones having selected audible frequencies, the frequency of an AC heating current is controlled within frequency limits. Generally, the frequency of the AC heating current is limited to a maximum frequency based on a frequency range of the inverter 34 (e.g., a range around a resonant frequency or base frequency of the inverter 34), switching frequency, and motor impedance (higher frequencies result in higher impedance, which consequently needs higher voltage). A minimum frequency is also determined, as frequency below a certain value can result in damage to the battery system 22.

For example, a base frequency is selected (e.g., 440 Hz), and maximum and minimum AC current frequencies are selected to establish a frequency range for sound generation. The frequency range is selected to maximize or increase heating efficiency (which is generally higher at higher frequencies), while balancing power requirements (higher frequencies need higher voltages). An example of a frequency range is between about 100 Hz to about 2 kHz).

Frequency components selected for sound generation are selected from within the frequency range, and may correspond to specific tones or musical notes. Frequencies and amplitudes may be stored in a lookup table or other data structure Stored amplitudes may be calibrated so that sound is generated according to a desire volume. In this way, noise can be reduced or transformed into sounds that are more pleasing to a user. In addition, or alternatively, the AC heating current can be controlled so that sounds emitted by the motor 20 and/or inverter 34 impart information to the user.

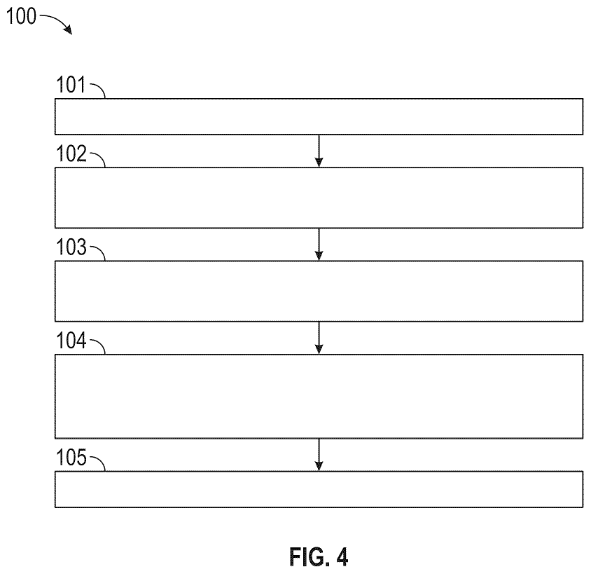

FIG. 4 illustrates embodiments of a method 100 of heating a battery system and monitoring battery temperature and other properties during heating. Aspects of the method 100 may be performed by any suitable processing device or system.

The method 100 is described in conjunction with the vehicle 10 and components thereof, but is not so limited, as the method 100 may be performed in conjunction with any suitable vehicle or battery assembly, and with any suitable device or system that utilizes battery storage. In addition, the method 100 is described as being performed by a controller in the vehicle 10, but is not so limited.

The method 100 includes a number of steps or stages represented by blocks 101-105. The method 100 is not limited to the number or order of steps therein, as some steps represented by blocks 101-105 may be performed in a different order than that described below, or fewer than all of the steps may be performed.

At block 101, a battery heating process is initiated. The process may be initiated based on a request entered by a user, a request generated by a vehicle system (e.g., the computer system 42). In an embodiment, the heating process is initiated in response to temperature measurements of the battery system 22 (e.g., the cycle is initiated if the battery temperature is below a selected temperature).

At block 102, one or more initial parameters, including an initial temperature of the battery system 22, are measured. Other parameters may be measured or determined, such as the state of charge (SOC) and nominal voltage of each cell.

Heating parameters are determined based on the initial temperature. Other factors or parameters may be considered when determining the heating parameters, such as ambient temperature, allocated time for heating and others. In an embodiment, the heating parameters include a target cell temperature and a desired rate of temperature increase. The initial parameters and heating parameters are used to determine a desired heating current frequency and amplitude.

In an embodiment, the AC heating current frequency is limited by a frequency range that is selected to provide for efficient heating. The frequency range includes a maximum frequency that can be based on limits in switching frequency (i.e., the frequency at which a switch turns on and off). For example, for sine waves, the maximum signal frequency should approximately 10 times lower than a maximum switching frequency. It is noted that embodiment are not limited to sine waves, as any suitable shape may be used, such as triangular or sawtooth waveforms, square waves, and others.

At block 103, a controller, such as the control module 40, receives a request for control of the AC heating current to generate a desired sound pattern (e.g., a single tone, a noise pattern, a melody, etc.). The request may be received from a user input, or may be automatically generated at initialization of the heating process.

In response to the request, frequency components are selected from the frequency range for one or more desired sounds of the desired sound pattern. For example, specific AC current frequencies are selected from within the frequency range that correspond to specific notes. In another example, an AC current pattern is selected for one or more sound patterns, such as songs or melodies (including individual notes and/or harmonies). Other sounds can be selected, such as white noise or rain sounds, which may be accomplished by dithering techniques on PWM or fundamental resonant frequency.

In an embodiment, available sounds (e.g., tones, harmonies, sound patterns (e.g., melodies), etc.) are stored in a lookup table or other data structure. Each sound may be stored with associated AC current parameters, such as current frequency and amplitude. A melody or sound pattern may include a series of frequencies, each having a duration and amplitude, to be applied. For a given melody, each note in the melody is stored as a frequency, duration and amplitude.

Available sounds may also be selected for specific conditions or statuses. For example, different tones and/or tone patterns may be associated with conditions such temperature, rate of temperature increase, start, end and fault conditions. Such configuration may be stored in the lookup table, and may be modified via the user interface 46, an app in a mobile device, or by remote control.

Available sounds may be selectable by a user, for example, from a data structure, such as a predefined library 82 stored in a location 84 (e.g., server or database) accessible by the control module 40 (See FIG. 3). The user, in an embodiment, can enter or add new tones, songs or melodies to the library. Users may be able to create own tones, songs or melodies based on application where a virtual keyboard is provided. Alternatively, existing songs can be tailored for AC heating via signal processing and/or machine learning or artificial intelligence.

For example, a sound request is received from the user, and the control module 40 determines the desired frequency and/or frequency pattern to be used when controlling the AC heating current to emit the desired sound pattern (e.g., a tone, noise pattern and/or melody). The controller may access the library or other data structure to determine the desired frequency and/or frequency pattern.

In an embodiment, the controller determines the desired AC heating current amplitude to achieve a desired sound level or volume. The amplitude (which may be a single constant amplitude or a variable amplitude) is determined based on characteristics of components of the vehicle 10, such as physical characteristics of the inverter 34 and the motor 20 and electrical characteristics (properties of the AC heating current path, such as impedance). Such characteristics affect the perceived volume of sound for a given amplitude and frequency. For example, sound volume is affected by the electrical path, as well as resonances and anti-resonances within the motor 20 and the inverter 34.

In an example, the desired amplitude is determined based on calibration information that associates current frequency and amplitude with sound volume. The calibration information may be accessed from the library or other storage location.

In another example, the desired amplitude is determined by applying frequency, phase and amplitude information (corresponding to the sound request) to a transfer function, and calculating an optimal amplitude based on the transfer function. The transfer function accounts for the physical and electrical characteristics, and is configured so that, for a given frequency, resonances are avoided, which allows for increasing or maximizing the heating current amplitude for a given sound level.

The transfer function may be customized for a given vehicle, for example, using manufacturer information and other information related to specific vehicle components. In an embodiment, the transfer function is generated and/or improved by monitoring output sounds (e.g. via a microphone in the vehicle or an external microphone) during heating processes and utilizing a machine learning process to learn the transfer function.

At block 104, a heating process is commenced and the heating current is then applied, for example, by controlling switches in the inverter 34. Amplitude and frequency of the current are controlled to effect the desired temperature rise rate and may be maintained until a measured temperature reaches a desired value.

During the heating process, the controller automatically adjusts the frequency within the frequency range, by adjusting an AC heating current command (e.g., a d-axis current command) to produce a corresponding AC heating current frequency that causes one or more vehicle components to emit the desired sound. For example, the AC heating current is controlled to emit a series of tones by adjusting the AC current frequency. The series of tones may constitute a selected melody or song, or simply a more pleasing tone. The duration of each tone can be controlled to control the tempo of the melody or song.

In another example, the AC current frequency and/or amplitude is adjusted as a function of the heating process, heating parameters and/or other conditions. For example, the frequency and/or volume is adjusted over time as a function of temperature. A pattern, such as an increase in frequency and/or volume, is adjusted so that the frequency and/or amplitude increases with increasing temperature and as the temperature approaches a desired or target temperature. In this example, a selected tone or pattern of tones may be emitted to indicate to the user that the AC heating process has ended. Other sounds or sound patterns may be generated to alert a user as to changes in conditions, such as the occurrence of a fault.

If the vehicle 10 includes multiple machines, AC current can be applied to the machines in a synchronized manner to produce the same sound or complementary sounds. For example, current applied to two machines can be controlled so that one machine emits a certain note and the other machine emits a note to produce a harmony.

At block 105, upon the battery pack 24 reaching the target or desired temperature, the heating process ends. The system may then return to normal operation.

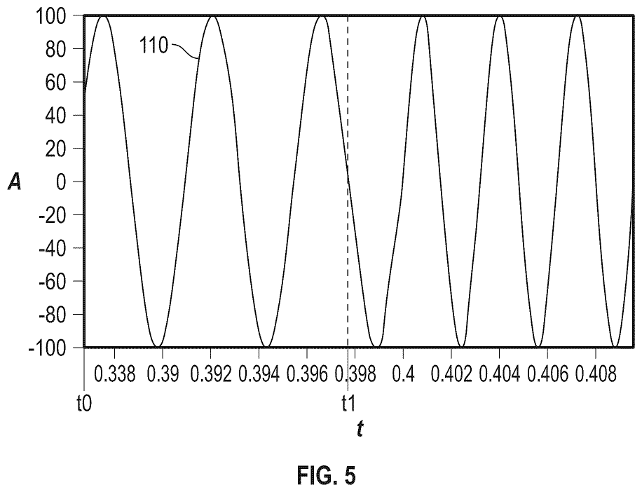

FIG. 5 shows an example of a tone pattern in a graph of d-axis-current amplitude A as a function of time t, and illustrates aspects of controlling the current frequency to generate specific notes and patterns. In this example, an AC current signal 110 is generated, which is a sinusoidal signal having a frequency that corresponds to a “C” note. The AC current signal frequency is constant from time to to time t₁. At time t₁, the frequency is increased to a frequency that corresponds to a C-sharp note.

As noted above, embodiment are not limited to sinusoidal shapes. AC heating current may take the form of any suitable oscillating waveform.

Transition between frequencies may be controlled so that there is a smooth transition between the notes. Generally, a smooth transition is a transition in which there are no abrupt jumps or changes in frequency. In an embodiment, frequency changes are enforced so that each change in frequency occurs at a zero-crossing point of a current signal. In addition, the phase of the signal can be adjusted as needed so that the signal is continuous and there are no abrupt changes in amplitude.

For example, as shown in FIG. 5, the change from the C frequency to the C sharp frequency occurs at a point where the AC current signal is at zero, and the phase of the signal is adjusted at time t₁ so that the signal remains continuous. Although not shown, an amplitude at or around the transition time ti may be reduced to reduce volume in between notes to highlight note transitions.

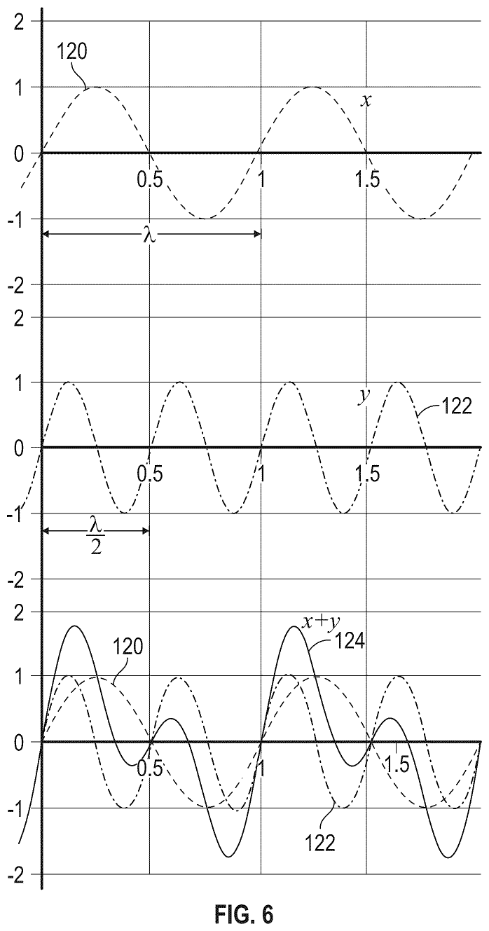

Different musical concepts can be applied, such as combining multiple notes to form a harmony, or combination of consonant notes or tones. FIG. 6 shows an example in which the frequency and amplitude of the AC heating current is controlled to emit a harmony (simultaneous combination of notes). In this example, a waveform 124 is constructed by combining two constant-frequency signals 120 and 122 (e.g., a frequency corresponding to a root note, and a frequency corresponding to firth or fifth).

As noted above, a lookup table or other data structure may be provided for use by the controller when adjusting the AC heating current. The lookup table stores current frequencies and frequency patterns, and may also store parameters for controlling sound volume. For example, the lookup table can be used to store voltage amplitude values corresponding to sound volumes. Alternatively, voltage amplitude can be determined using a polynomial equation.

The lookup table or other data structure may also store waveform patterns for specific tones, sounds or melodies. For example, a waveform pattern is stored for each of one or more melodies or songs (e.g., happy birthday, ode to joy, ice-cream truck music, adaptation of one or more popular songs, etc.). Patterns for other types of sounds may be stored (e.g., rain sounds, white noise, etc.). For example, a random function is used for the AC heating current waveform, in which the random function is generated within a stored frequency range (within a bandwidth set for inverter control), to create a broad-band white noise that is less annoying than pure tones.

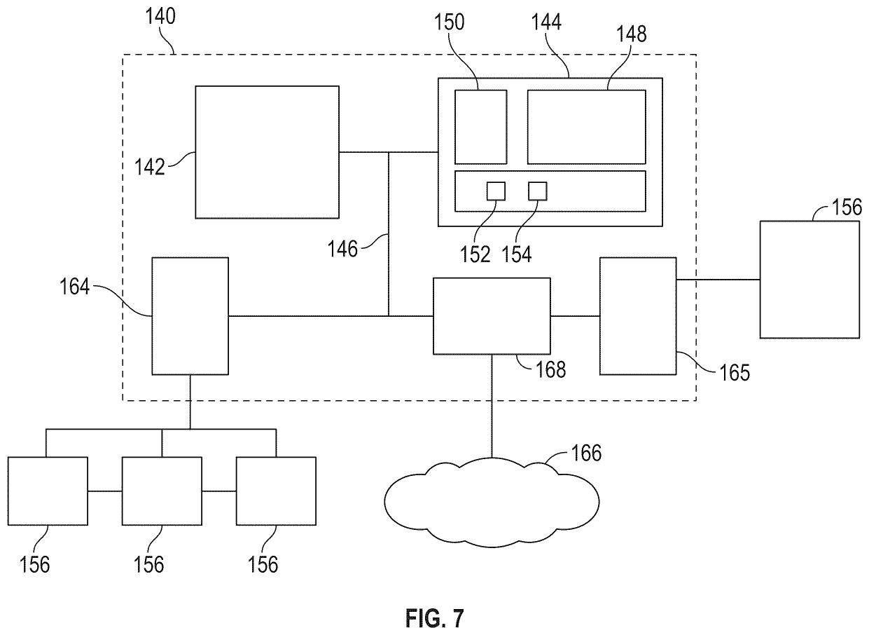

FIG. 7 illustrates aspects of an embodiment of a computer system 140 that can perform various aspects of embodiments described herein. The computer system 140 includes at least one processing device 142, which generally includes one or more processors for performing aspects of image acquisition and analysis methods described herein.

Components of the computer system 140 include the processing device 142 (such as one or more processors or processing units), a memory 144, and a bus 146 that couples various system components including the system memory 144 to the processing device 142. The system memory 144 can be a non-transitory computer-readable medium, and may include a variety of computer system readable media. Such media can be any available media that is accessible by the processing device 142, and includes both volatile and non-volatile media, and removable and non-removable media.

For example, the system memory 144 includes a non-volatile memory 148 such as a hard drive, and may also include a volatile memory 150, such as random access memory (RAM) and/or cache memory. The computer system 140 can further include other removable/non-removable, volatile/non-volatile computer system storage media.

The system memory 144 can include at least one program product having a set (e.g., at least one) of program modules that are configured to carry out functions of the embodiments described herein. For example, the system memory 144 stores various program modules that generally carry out the functions and/or methodologies of embodiments described herein. A module 152 may be included for performing functions related to monitoring a battery system, and a module 154 may be included to perform functions related to battery heating and sound generation as described herein. The system 140 is not so limited, as other modules may be included. As used herein, the term “module” refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The processing device 142 can also communicate with one or more external devices 156 as a keyboard, a pointing device, and/or any devices (e.g., network card, modem, etc.) that enable the processing device 142 to communicate with one or more other computing devices. Communication with various devices can occur via Input/Output (I/O) interfaces 164 and 165.

The processing device 142 may also communicate with one or more networks 166 such as a local area network (LAN), a general wide area network (WAN), a bus network and/or a public network (e.g., the Internet) via a network adapter 168. It should be understood that although not shown, other hardware and/or software components may be used in conjunction with the computer system 40. Examples include, but are not limited to: microcode, device drivers, redundant processing units, external disk drive arrays, RAID systems, and data archival storage systems, etc.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A system for thermal control of a battery system, comprising:
a heating control module configured to generate an alternating current (AC) heating current and heat the battery system to a desired temperature by applying the AC heating current to the battery system, the heating control module configured to control a shape of the AC heating current to cause a component of the battery system to emit a selected sound pattern having a selected frequency, amplitude and shape.

2. The system of claim 1, wherein the component of the battery system includes at least one of an inverter, an electric motor connected to the inverter, and a motor housing.

3. The system of claim 1, wherein the heating control module is configured to control a heating current frequency to cause the component to generate the selected sound pattern.

4. The system of claim 3, wherein the heating control module is configured to change the heating current frequency to generate a plurality of successive tones.

5. The system of claim 4, wherein the change of the heating current frequency is made during a zero-crossing of the AC heating current, and a phase of the AC heating current is controlled to provide a smooth transition between the successive tones.

6. The system of claim 4, wherein each tone of the plurality of successive tones has a respective frequency selected to generate a musical pattern.

7. The system of claim 1, wherein the heating control module is configured to control the shape of the heating current to generate a simultaneous combination of consonant musical tones.

8. The system of claim 1, wherein the heating control module is configured to control the shape of the heating current to generate a pattern of one or more tones, the pattern indicative of at least one of: a condition of the battery system and a status of a battery heating process.

9. A method of thermally controlling a battery system of a vehicle, comprising:
controlling a heating control module to generate an alternating current (AC) heating current;
heating the battery system to a desired temperature by applying the AC heating current to the battery system during a battery heating process; and
during the battery heating process, controlling a shape of the AC heating current to cause a component of the battery system to emit a selected sound pattern having a selected frequency, amplitude and shape.

10. The method of claim 9, wherein the component of the battery system includes at least one of an inverter, an electric motor connected to the inverter, and a motor housing.

11. The method of claim 9, wherein controlling the shape including controlling a heating current frequency to cause the component to generate the selected sound pattern.

12. The method of claim 11, wherein the shape of the AC heating current is controlled so that the AC heating current defines a plurality of successive tones, and controlling the shape includes changing the heating current frequency at a selected time to transition between adjacent tones, wherein the heating current frequency is changed at zero-crossing of the AC heating current, and a phase of the AC heating current is controlled to provide a smooth transition between the adjacent tones.

13. The method of claim 9, wherein controlling the shape of the AC heating current includes selecting an amplitude of the AC heating current based on a transfer function, the transfer function relating the amplitude to a volume of the selected sound pattern based on characteristics of the vehicle.

14. The method of claim 9, wherein the shape of the AC heating current is controlled to generate a simultaneous combination of consonant musical tones.

15. The method of claim 9, wherein the shape of the AC heating current is controlled to generate a pattern of one or more tones, the pattern indicative of at least one of: a condition of the battery system and a status of a battery heating process.

16. A vehicle system comprising:
a memory having computer readable instructions; and
a processing device for executing the computer readable instructions, the computer readable instructions controlling the processing device to perform a method including:
controlling a heating control module to generate an alternating current (AC) heating current;
heating a battery system to a desired temperature by applying the AC heating current to the battery system during a battery heating process; and
during the battery heating process, controlling a shape of the AC heating current to cause a component of the battery system to emit a selected sound pattern having a selected frequency, amplitude and shape, wherein the component of the battery system includes at least one of an inverter, an electric motor connected to the inverter, and a motor housing.

17. The vehicle system of claim 16, wherein the shape of the AC heating current is controlled to generate a simultaneous combination of consonant musical tones.

18. The vehicle system of claim 16, wherein controlling the shape including controlling a heating current frequency to cause the component to generate the selected sound pattern.

19. The vehicle system of claim 18, wherein the selected sound pattern includes a plurality of successive tones, each successive tone having a respective frequency selected to generate a musical pattern.

20. The vehicle system of claim 16, wherein the shape of the AC heating current is controlled to generate a pattern of one or more tones, the pattern indicative of at least one of: a condition of the battery system and a status of a battery heating process.
